SEQUENCE LISTING (6 sequences)

SEQ ID NO: 1 - DNA, 18 bp, synthetic construct
  source 1..18: mol_type = other DNA
gccatctcctgatgacgc

SEQ ID NO: 2 - DNA, 18 bp, synthetic construct
  source 1..18: mol_type = other DNA
atttaccgcagccagacg

SEQ ID NO: 3 - DNA, 40 bp, synthetic construct
  source 1..40: mol_type = other DNA
ctggggcgaggtcgtggtattccgacaaacaccacgaatt

SEQ ID NO: 4 - DNA, 42 bp, synthetic construct
  source 1..42: mol_type = other DNA
cattttgcagctgtacgctcgcagcccatcatgaatgttgct

SEQ ID NO: 5 - DNA, 24 bp, synthetic construct
  source 1..24: mol_type = other DNA
ctttgtaacaacctgtcatcgaca

SEQ ID NO: 6 - DNA, 25 bp, synthetic construct
  source 1..25: mol_type = other DNA
atcaatctcgatatccatgaaggtg

(19) United States
(12) Patent Application Publication
(10) Pub. No.: US 2026/0084157 A1
(43) Pub. Date: Mar. 26, 2026

(54) PORTABLE DEVICES AND METHODS FOR IN SITU NUCLEIC ACID DETECTION IN WATER SAMPLES

(71) Applicant: University of Florida Research Foundation, Inc., Gainesville, FL (US)

(72) Inventors: Zhonghui Hugh Fan, Gainesville, FL (US); Carlos Manzanas, Gainesville, FL (US); Elise Morrison, Gainesville, FL (US); Todd Osborne, Gainesville, FL (US)

(21) Appl. No.: 19/112,322

(22) PCT Filed: Nov. 20, 2023
(86) PCT No.: PCT/US2023/080451

§ 371 Date: Mar. 17, 2025

Related U.S. Application Data
(60) Provisional application No. 63/428,537, filed on Nov. 29, 2022.

(51) Int. Cl. B01L 7/00; B01L 3/00

(52) U.S. Cl. CPC B01L 7/52; B01L 3/502738; B01L 2200/025; B01L 2200/10; B01L 2300/042; B01L 2300/069; B01L 2300/0867; B01L 2300/126; B01L 2300/1805; B01L 2400/049; B01L 2400/0616

(57) ABSTRACT

The present disclosure provides for devices for preparing a sample for nucleic acid detection, methods of detection of a nucleic acid in a sample, system for preparing and analyzing nucleic acid, and the like. The present disclosure provides for an on-site testing device, system, and method for pathogen detection in water. The device, system, and method can process large sample volumes using a paper-based sample preparation method, amplify DNA using loop-mediated isothermal amplification (LAMP) or amplify RNA using reverse transcription LAMP (RT-LAMP), and detect amplicons based on color change or other signals.

### CROSS-REFERENCE TO RELATED APPLICATIONS

This application claims priority to, and the benefit of, co-pending U.S. provisional application entitled “PORTABLE DEVICES AND METHODS FOR IN SITU NUCLEIC ACID DETECTION IN WATER SAMPLES” having Ser. No. 63/428,537, filed Nov. 29, 2022, which is incorporated by reference in its entirety.

### CROSS REFERENCE TO SEQUENCE LISTING

The genetic components described herein are referred to by sequence identifier numbers (SEQ ID NO). The SEQ ID NOs correspond numerically to the sequence identifiers <400>1, <400>2, etc. The sequence listing in written computer readable format (CRF) as a text file named “222112_2070_Sequence_Listing.xml” created on Nov. 16, 2023, and having a size of 6,484 bytes, is incorporated by reference in its entirety.

### BACKGROUND

Rapid and efficient detection of pathogens in water sources is necessary for human and environmental health. Conventional methods for detecting pathogens in water are mostly culture-based approaches and separation/filtration techniques in laboratories. Although these conventional laboratory assays are still the standard methods since they are accurate and highly sensitive, they require bulky and costly instrumentation, trained personnel, and long turnaround times. Most existing portable platforms suffer from issues such as low sample volume, high limits of detection (LoD), sample preparation requirements, and the need for trained personnel. There is a need for low-cost, sensitive, portable platforms for on-site detection.

### SUMMARY

Briefly described, in various aspects, the present disclosure provides for devices for preparing a sample for nucleic acid detection, methods of detection of a nucleic acid in a sample, and the like.

The present disclosure provides for a device for preparing a sample for nucleic acid detection comprising: a buffer unit comprising a plurality of buffer wells arranged in a circle type shape, wherein each buffer well comprises a ball valve in a bottom of the well; a mixing unit comprising a mixing well and a pin, wherein the mixing unit is connected to a bottom of the buffer unit such that the mixing unit is rotatable to align with each buffer well in turn, wherein when the mixing unit is aligned with a buffer well the pin engages with the ball valve to release fluid from the buffer well into the mixing well; and a detection unit removably coupled to a bottom of the mixing unit to receive fluids from the mixing well; and a waste container coupled to the bottom of the mixing unit, wherein the waste container comprises a well that receives fluids from the detection unit.

The present disclosure provides for a method of detection of a nucleic acid in a sample, comprising: providing a fluid sample to a first buffer well of a device, the device comprising: a buffer unit comprising a plurality of buffer wells arranged in a circular type shape, wherein each buffer well comprises a ball valve in a bottom of the well, wherein a first buffer well contains a lysis solution, wherein a second buffer well contains a binding buffer, wherein a third buffer contains a first wash buffer, and a fourth buffer well contains a second wash buffer; a mixing unit comprising a mixing well and a pin, wherein the mixing unit is connected to a bottom of the buffer unit such that the mixing unit is rotatable to align with each buffer well in turn, wherein when the mixing unit is aligned with a buffer well the pin engages with the ball valve to release fluid from the buffer well into the mixing well; and a detection unit removably coupled to a bottom of the mixing unit to receive fluids from the mixing well; rotating the mixing unit or the buffer unit to engage the pin with the first buffer well such that the sample and the lysis solution releases into the mixing unit; rotating the mixing unit or the buffer unit to engage the pin with the second buffer well such that the binding buffer releases into the mixing unit; rotating the mixing unit or the buffer unit to engage the pin with the third buffer well such that the first wash buffer releases into the mixing unit; rotating the mixing unit or the buffer unit to engage the pin with the fourth buffer well such that the second wash buffer releases into the mixing unit; and removing the detection unit once all fluids have drained from the mixing unit through the detection unit, and wherein the detection unit contains nucleic acid obtained from the fluid sample.

The present disclosure provides for a system for preparing a sample for nucleic acid detection and for nucleic acid detection comprising: a device as described above and herein and a heating unit, wherein the detection unit is adjacent the heating unit.

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure.

FIG. 1.1 provides a diagram of an exploded view of the device components in accordance with embodiments of the present disclosure.

FIG. 1.2A illustrates a ball-based valving mechanism in accordance with embodiments of the present disclosure. FIGS. 1.2B and 1.2C are camera images of a prototype of an embodiment of the device. In FIG. 1.2B, the pin is visible and the ball valves are closed. In FIG. 1.2C, the buffer unit has been rotated so that the pin has engaged the ball valve and the ball in the first well is lifted.

FIGS. 1.3A and 1.3B show real-time LAMP amplification for E. coli detection using purified E. coli DH5-alpha DNA. FIG. 1.3A: Fluorescent signal of 8×10⁴, 8×10³, 8×10², and 8×10¹ bacterial genome equivalents (GEs) per reaction as a function of LAMP time. NTC, no-template control. FIG. 1.3B: Calibration curve showing the threshold time (Ct) as a function of GEs in each reaction (in log scale). The results were generated from three replicates of each concentration of E. coli DH5-alpha DNA samples. The error bars indicate one standard deviation.

FIG. 1.4A is a camera image of the reaction tubes taken under room lights after LAMP assay at 62.5° C. for 45 min. Amount of E. coli DNA are 300 genome equivalents (GEs) for the positive control (P), and the others are marked on the tubes, 30, 3, and 1 GEs, as well as a negative control (N). FIG. 1.4B shows the same tubes shown in FIG. 1.4A under blue LED. FIG. 1.4C shows gel electrophoresis of those samples in FIG. 1.4A.

FIGS. 1.5A-1.5D are camera images of results of the tests from the sample #3, Pellicer Creek (P), and sample #4, Whitney Lab Docks (W), comparing the detection of filtered and unfiltered replicates of both locations, along with a positive control (left), and a no-template control (right).

FIG. 1.6A shows the theoretical sample preparation time needed to process 1 mL water samples through the chromatography paper as a function of the paper diameter, assuming a flow rate velocity of 4.33 mm/min provided by the manufacturer. The sample preparation time was calculated using Equation 1. FIG. 1.6B shows the volume needed for the LAMP mix to reach the height that 25 UL mix reaches in a detection unit that uses a 4 mm diameter, as a function of the paper diameter. The volume needed was calculated using Equation 2.

FIGS. 1.7A and 1.7B are camera images of results for the spiked water samples containing 3.5% (top left), 2.0% (top right), 0.5% (bottom left), and 0.0% (bottom right) of salt concentration in weight percentage, along with two positive controls (P, left), and two no-template controls (N, right). FIG. 1.7A was taken under the room lights. FIG. 1.7B was taken under blue LED and a yellow filter to enhance the fluorescence signal.

FIGS. 1.8A and 1.8B are camera images of the results from 3 replicates for each location where the environmental water samples were collected, sample #1, Whitney Lab Docks (WL, top), and sample #2, Mouth of Pellicer Creek (MP, bottom), along with a positive control (P, left), and a no-template control (N, right). FIG. 1.8A was taken under room lights. FIG. 1.8B was taken under blue LED and yellow filter.

FIG. 2.1 is a schematic representation of an embodiment of the process flow of detecting K. brevis on the spot. VLEAD consists of three components, a buffer unit at the top, a mixing unit in the middle, and a detection unit at the bottom.

FIG. 2.2 is a schematic representation of the valve design in accordance with embodiments of the present disclosure. Valve design shows (1) closing on the left when a bearing ball functions as a plug for the reservoir and (2) opening on the right when the ball is pushed up by a pin.

FIG. 2.3 is an illustration of an exploded view of the detection unit in FIG. 2.1. The inset on the left is a laminated paper pad.

FIG. 2.4A is a camera image showing RT-LAMP carried out in a water bath inside a coffee mug. The insert (top) is a photograph of an embodiment of the detection unit. FIG. 2.4B is a camera image taken with a smartphone, showing the detection units under the ambient light and blue LED flashlight. Devices 1-3 contains 1, 0.5, 0.1 PFU of ZIKV spiked in human urine samples while device 4 is a negative control.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

The present disclosure provides for devices for preparing a sample for nucleic acid detection, methods of detection of a nucleic acid in a sample, system for preparing and detecting nucleic acids, and the like. The present disclosure provides for an on-site testing device, system, and method for pathogen detection in water. The device, system, and method can process large sample volumes using a paper-based sample preparation method, amplify DNA using loop-mediated isothermal amplification (LAMP) or amplify RNA using reverse transcription LAMP (RT-LAMP), and detect amplicons based on color change, fluorescence, or other signals.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, biomedical engineering, and the like, which are within the skill of the art.

The following examples are put forth so as to provide those of ordinary skill in the art with a complete disclosure and description of how to perform the methods and use the devices disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

As used herein, the following terms have the meanings ascribed to them unless specified otherwise. In this disclosure, “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

### Definitions

The term “microorganism” or “microbe,” as used herein, refers to a small (often, but not always, microscopic) organism that is typically, but not exclusively, single cellular, and includes organisms from the Kingdoms bacteria, archaea, protozoa, and fungi. Viruses are also classified as microorganisms in the present disclosure document even though they are not living organisms by themselves.

Pathogens, as used herein can refer to bacteria, viruses, algae, parasites or other undesirable RNA- or DNA-containing source.

### General Discussion

The present disclosure provides for devices for preparing a sample for nucleic acid detection, methods of detection of a nucleic acid in a sample, systems for preparing and analyzing nucleic acids, and the like. In particular, the present disclosure provides for an on-site testing devices, methods and systems for pathogen detection in water. Advantageously, the device, method and system can process large sample volumes (e.g., about 1 ml to 10 mL or about 1 mL to 1000 mL) using a paper-based sample preparation method, for example, amplify DNA using loop-mediated isothermal amplification (LAMP) or amplify RNA using reverse transcription LAMP (RT-LAMP), and detect amplicons based on color change, fluorescence, or other signals.

In general, the present disclosure provides for a device (which can be 3D printed or molded) having ball-based valves for sequential delivery of the reagents needed for cell lysis, DNA enrichment and purification. Resultant DNA is concentrated onto a chromatography paper, glass fibers, FTA card substrate, or the like. LAMP can then be achieved by connecting the device to a portable heat source. In some embodiments, the heat source is a battery-powered, smart coffee mug that functions as a water bath, providing a constant temperature. Alternatively, other heating devices or systems can be used as can be appreciated by one of ordinary skill in the art. In some embodiments, pathogens can be visually detected above a threshold limit of detection (LoD) using colorimetric detection (e.g., SYBR Green dye, Malachite Green, hydroxynaphthol blue, phenol red, calcein, or leuco crystal violet) or turbidity. In a particular embodiment, detection of E. coli in environmental water samples in about 1 hour using this testing system has been achieved.

Advantageously, the device can be handheld and portable. In some embodiments, the device can be about 7.5 cm high and about 10 cm in diameter. The height and diameter can be modified to accommodate different volumes of fluid or can change if the waste container is not adapted for vacuum removal.

Advantageously, the methods, systems and devices provided herein can be used to detect pathogens in such as municipal water sources, fresh water, salt water, ocean water, recreational water, or treated water. Pathogens can also be detected in wastewater to monitor disease outbreaks or prevalence within communities. Examples include, but are not limited to bacteria, algae, influenza viruses, coronaviruses, rhinoviruses, and adenoviruses. Specific pathogens can include such as E. coli, SARS-CoV-2, Zika virus, Karenia brevis, Prorocentrum minimum, polio virus, anthrax, malaria virus, Salmonella, Staphylococcus, Vibrio cholera, Legionella, Shigella, Campylobacter Jejuni, Hepatitis virus, Giardia Lamblia, Legionella Pneumophila, Cryptosporidium, and the like.

The device integrates all the necessary steps for a nucleic acid assay, including lysis, DNA enrichment and purification, amplification, and detection. No lab is needed, and the assay can be performed much faster than culture-based approaches. Additionally, contamination risk during DNA enrichment is reduced because no sample transfers are needed. A traditional elution step is also not needed. In other embodiments, by including reverse transcriptase, the device can perform RT-LAMP, where the nucleic acid is RNA.

In some embodiments, the device includes a buffer unit having a plurality of buffer wells arranged in circle type shape (e.g., a circle, a part of circle or semi-circle (e.g., part of a circle with a wedge cut out, see Figures for illustrative examples) such as 3/4 circle, 4/5 circle, n/(n+1) (n=3 to 10 or 3 to 8 or 3 to 6) circle, and the like). Each buffer well has a ball valve in the bottom of the well. The buffer unit sits atop a mixing unit. The mixing unit houses a mixing well and contains a pin. When the mixing unit is connected to the bottom of the buffer unit, the mixing unit can be rotated to align with each buffer well in turn. Alternatively, the buffer unit can be rotated while the mixing unit is stationary. When the mixing unit is aligned with a buffer well (e.g., a first buffer well, a second buffer well, a third buffer well, a fourth buffer well, etc.), the pin engages with the ball valve to release buffer from the buffer well into the mixing well. Advantageously, the circular type shape arrangement of the mixing wells and rotational sequential delivery allows the device to be more compact and handle larger sample volumes than linear sliding devices.

In some embodiments, the pin can be oriented vertically, horizontally, or in another position relative to the vertical axis of the buffer well. The orientation of the pin is set to function to release the fluid in the buffer well upon rotation of the buffer unit.

In some embodiments, the mixing well is funnel shaped to facilitate fluid flow to the detection unit. The mixing unit contains a drain, which drains into a detection unit attached to the inferior side of the top of the mixing unit. In some embodiments, the detection unit can be affixed to a protrusion on the mixing unit. In some embodiments, the protrusion can be such as a post, a short tube, or a Luer lock. The protrusion guides the fluid to the well in the detection unit and prevents spillage outside of the detection unit. In other embodiments, the detection unit can connect to the mixing unit via a clip or snap into a recess on the mixing unit. In some embodiments, the drain has a diameter of about 5 mm and the well in the detection unit has a diameter of approximately 4 to 10 mm.

In some embodiments, either the entire buffer unit or the first well of the buffer unit can be enlarged to accommodate a larger volume of sample fluid.

In some embodiments, the device can include one or more filters to remove particulate matter. In some embodiments, the filter can be included in the first well to filter particulate matter. In other embodiments, the filter can be installed with the water sampling process. In yet other embodiments, a filter can be located above the detection unit or as a layer in the detection unit. In some embodiments, a filter can be included at more than one location.

In some embodiments, the device is supplied with necessary buffers and/or reagents provided in the wells. The device can be provided such that the buffer unit or individual wells have a seal on the top. For example, the top can be laminated with a thin plastic layer, or sealed with a film (e.g. parafilm). Alternatively, each of the wells can be threaded and closed with a threaded cap. In other embodiments, a cap can be added with a pin of an appropriate length that touches the ball so that the ball is fixed when the cap is in place. When the cap is removed, the ball can be unfixed and it functions as a valve.

In some embodiments, the ball contains a breakable seal (e.g., wax or film) so that the well remains sealed at the bottom until it engages with the pin of the mixing unit.

In some embodiments the LAMP mix or RT-LAMP mix is added by disposable pipette into the well layer of the detection unit once the detection unit has been removed. In other embodiments, the buffer unit can include a fifth well for the mix.

The detection unit includes a well containing an absorbent layer for enrichment of the nucleic acid. In some embodiments, the absorbent layer is chromatography paper. In some embodiments, the absorbent layer is cellulose paper, a membrane, or glass microfiber paper. In some embodiments, the absorbent layer can be laminated between layers of thermoplastic film to form a pad. In some embodiments, the pad can be affixed to the detection unit well with a double-sided adhesive tape.

A waste container can be connected to the bottom of the mixing unit such that fluid flowing from the mixing unit is collected in the waste container after flowing through the detection unit. In some embodiments, the waste container can include a vacuum connection. Advantageously, by applying vacuum suction or syringe withdraw, the filtration process of fluid through the detection unit can be accelerated.

In some embodiments, the device can be included in a system further including a heating unit. The heating unit can be such as an incubator or temperature-controlled water bath. In various embodiments, the heating unit can be battery-operated or otherwise powered by a portable power source, such as via a connection to a laptop or vehicle. In some embodiments, the heating unit is a temperature-controlled travel mug. Advantageously, multiple detection units can be incubated at the same time in the heating unit, allowing for efficient processing of multiple samples.

The system can also include a vacuum unit. In some embodiments, the vacuum unit can be a syringe. The syringe can be attached to the vacuum connection via tubing.

In some embodiments, the device is a single-use device. The device may be rapid prototyped, injection molded, or made by other suitable manufacturing processes.

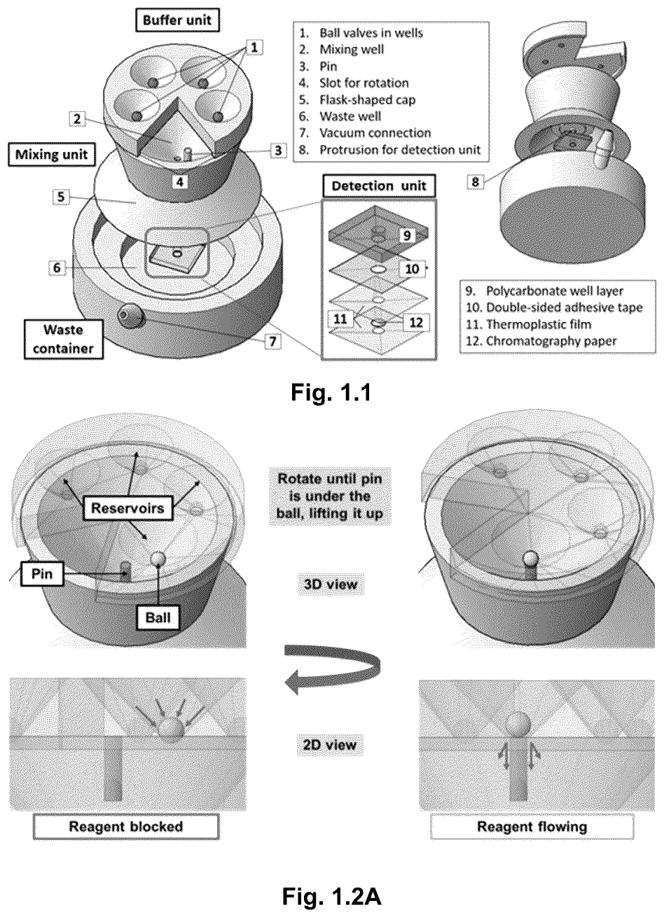

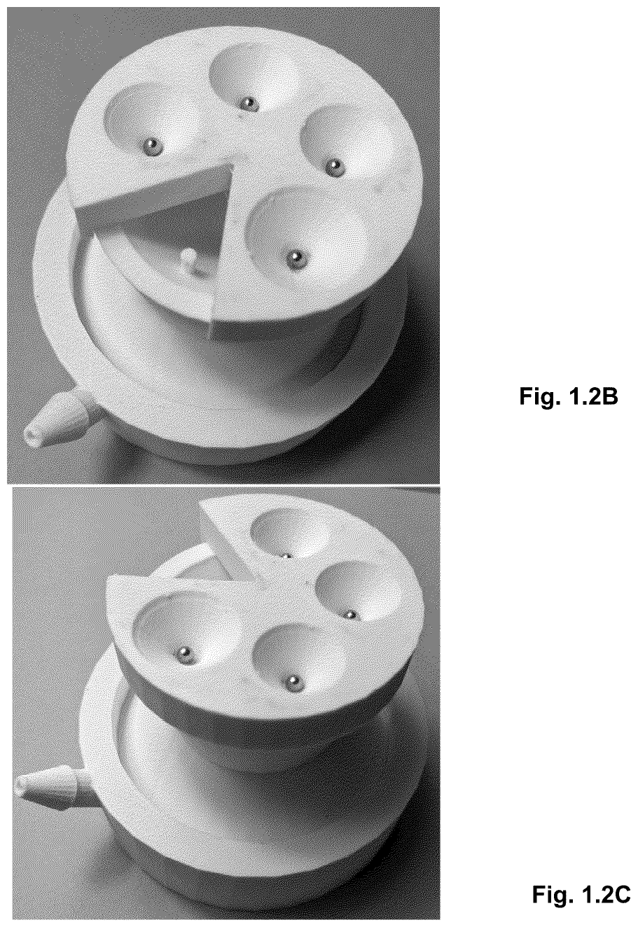

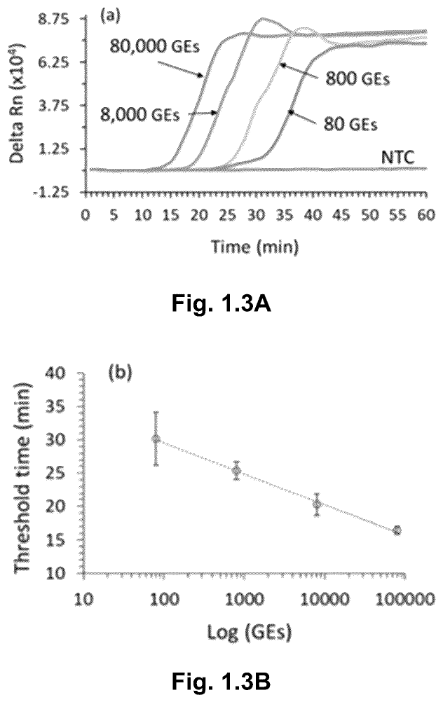

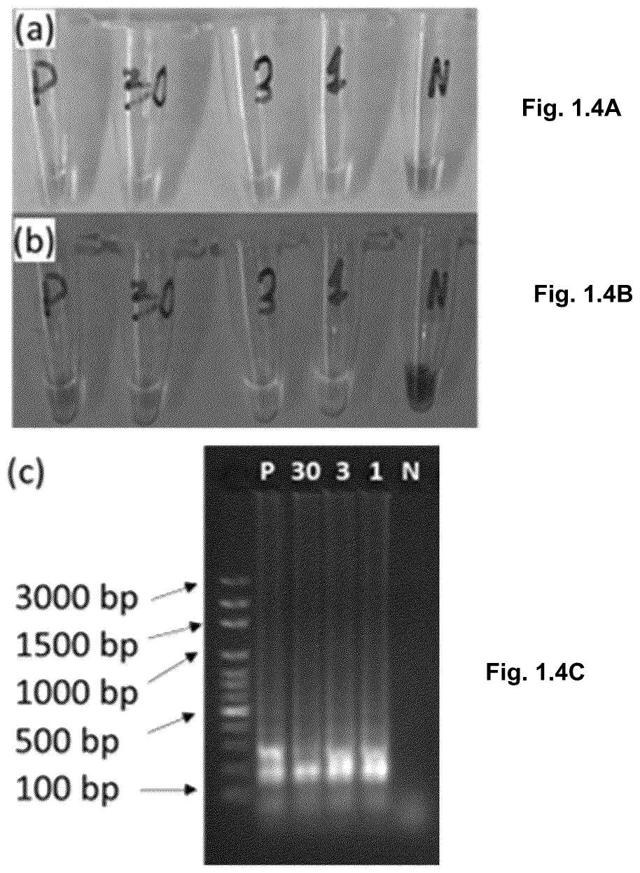

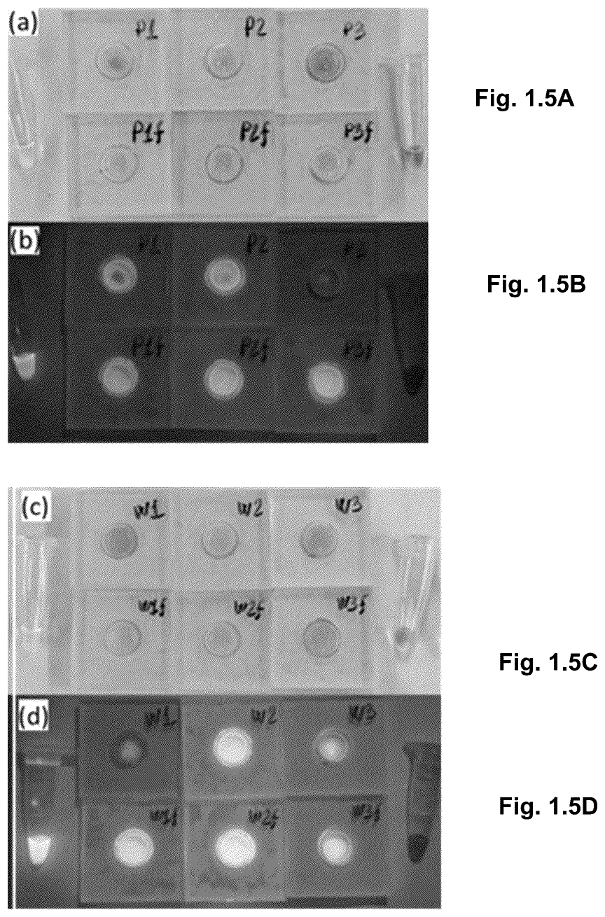

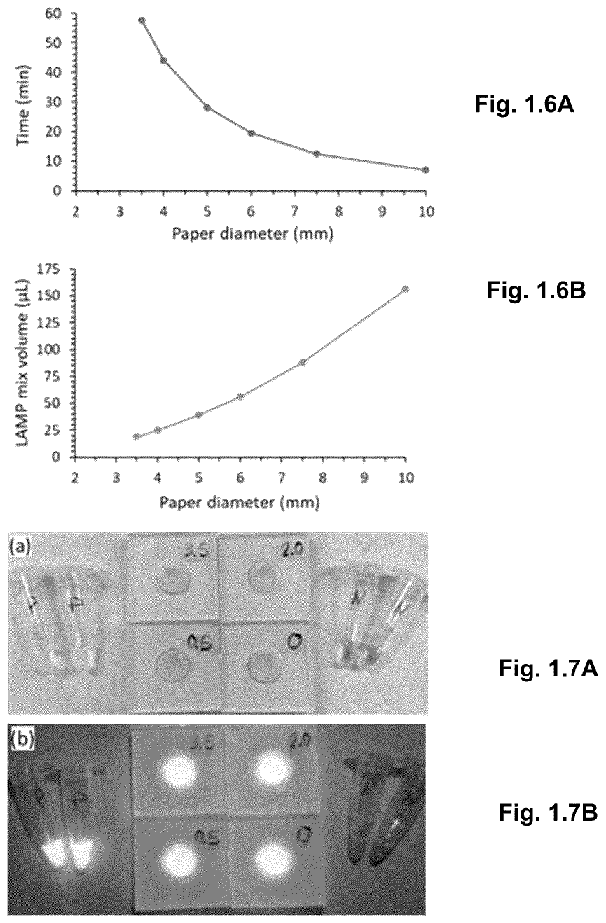

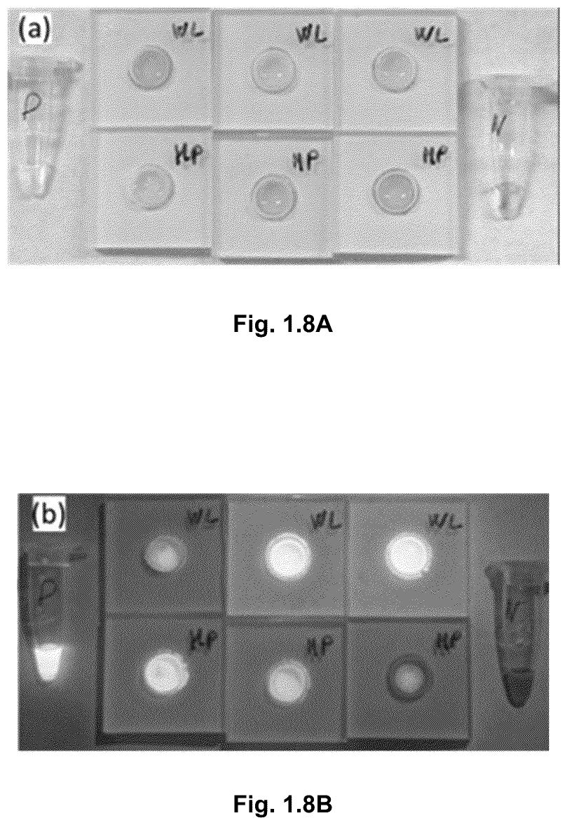

Having described the present disclosure generally, additional details are provided. FIG. 1.1 illustrates an example of the device. The buffer unit at the top contains four reservoirs and an opening. These four reservoirs are for the lysis buffer, binding buffer, and 2 wash buffers. The opening at the bottom of each well is blocked by a stainless-steel ball (1) to prevent the reagents from flowing down until it is desired. The mixing unit in the middle is in a funnel shape to enhance mixing in the mixing well (2) and make the reagents and sample pass through the paper in the detection unit (9-12), which is inserted by the protrusion (8) at the bottom of the mixing unit. The mixing unit has a pin (3) that pushes the ball up, opening the valve and allowing the reagent to go down when the buffer unit is rotated to align the pin (3) with the ball (1). The buffer unit includes a slot (4) to allow for rotation. The mixing unit sits atop the waste container, connected by a cap. Finally, the waste container in the bottom serves to both collect all the waste in waste well (6) and to accelerate the filtration process by connecting a vacuum or suction mechanism to it via connection (7).

In some embodiments, the slot can be replaced by a tab or other mechanism to facilitate rotation of the buffer unit while keeping the mixing unit closed to contaminants.

In some embodiments, the vacuum or suction mechanism can be such as a syringe, where the withdrawal action of the syringe creates a suction. In other embodiments, the vacuum mechanism can be such as a lab vacuum line if used in a lab or a vacuum pump when used in the field.

In some embodiments, such as the one shown in FIG. 1.1, the waste container cap is flask-shaped (e.g., a truncated cone). This shape allows for the unit to balance a large volume of waste without sacrificing stability from a taller arrangement. In other embodiments, the cap could be flat and the waste container could be a wider, deeper shape to achieve the same volume.

FIGS. 1.2A-C illustrates the ball-based valving mechanism. As shown on the left (FIG. 1.2A), the valve is closed when the ball blocks the reagent from flowing down. On the right, the valve is opened after the buffer unit is rotated and the pin is aligned with the ball, lifting up the ball and allowing the reagents to flow into the mixing unit. FIGS. 1.2B and 1.2C respectively show the closed valve and the open valve when aligned with the pin.

The present disclosure provides for methods for detecting nucleic acid in a sample. In particular, the methods of present disclosure can be used to detect harmful algal blooms (see Example 2). Detection can be performed in water samples at the collection site using the devices and systems provided above. In an aspect, the limit of detection (LoD) is lower than 100 CFU/100 mL.

In an aspect, the present disclosure provides for methods of detecting a nucleic acid in a sample (e.g., salt water, fresh water, ocean water, recreational water, waste-water or treated water). The method can include the use of a device or system as described above. A fluid sample (e.g., a volume of 1 mL to 1000 mL) can be disposed into a first buffer well of the device, where the first buffer well includes a lysis solution. The device also includes a second buffer well that contains a binding buffer, a third buffer that contains a first wash buffer, and a fourth buffer well that contains a second wash buffer (additional buffer wells can be included that contain other materials that can be used in the process). The method includes rotating the mixing unit or the buffer unit to engage the pin with the first buffer well such that the sample and the lysis solution releases into the mixing unit. Next the method includes rotating the mixing unit or the buffer unit to engage the pin with the second buffer well such that the binding buffer releases into the mixing unit. Then the method includes rotating the mixing unit or the buffer unit to engage the pin with the third buffer well such that the first wash buffer releases into the mixing unit. Next the method includes rotating the mixing unit or the buffer unit to engage the pin with the fourth buffer well such that the second wash buffer releases into the mixing unit. The method includes removing the detection unit once all fluids have drained from the mixing unit through the detection unit, and where the detection unit contains nucleic acid obtained from the fluid sample. In an aspect, the method includes adding an amplification mixture (e.g., a LAMP mixture or RT-LAMP mixture) to the detection unit. In an aspect, the method includes pipetting the amplification mixture to the detection unit. In an aspect, the method includes reconstituting the dried or lyophilized amplification mixture into the detection unit. In another aspect, the method includes adding the amplification mixture via a fifth buffer well before the detection unit is removed. The method can also include heating the detection unit in a heating unit to amplify the nucleic acid, where the heating unit provides a temperature of about 57° C. to 67° C.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

### Introduction

Water resources around the world are subjected to a variety of contaminants, either biological or nonbiological, and their presence beyond certain levels can be harmful for human beings¹. Good public health requires regular water quality monitoring to prevent people from contracting diseases. Worldwide, approximately 1.6 million people die every year due to waterborne diseases caused by biological contaminants¹, which affects countries of all economic levels². Pathogens are the major biological contaminants in water and thus, it is important to monitor the presence of these in recreational and drinking water sources. Some of these pathogens include Salmonella, Staphylococcus, Vibrio cholera, Legionella, Shigella, Escherichia coli (E. coli), and other coliform bacteria³. These pathogens can be introduced to water rapidly and can enter the human body directly by drinking water or indirectly during bathing. For this reason, acceptable limits of some of these pathogens have been defined in legislation by different organizations such as the World Health Organization (WHO), the United States Environmental Protection Agency (US EPA), or the European Union⁴.

Fecal pollution is the main source for disease-causing agents in water¹, ⁴, including bacteria present in excreta from humans and warmed-blooded animals. E. coli is a type of bacteria that normally lives in the intestines of warm-blooded animals, however, there are some toxic strains that could cause abdominal cramps, vomiting, and diarrhea. Even small amounts of contaminated water with these toxic strains can cause illness⁵. Since humans and warm-blooded animals have E. coli present in their intestines, and their bacteria are released through feces, E. coli is the primary organism as an indicator of fecal contamination in fresh water⁴.

The US EPA reported an updated criteria in 2012 with a recommendation for fresh and marine water quality in recreational water⁶. They reported 2 criteria, one for an estimated illness rate (NGI) of 36 per 1000 primary contact recreators, and one for 32 per 1000 primary contact recreators. The recommended criteria for E. coli in fresh water for the NGI of 32 per 1000 primary contact recreators in any 30-day interval is a geometric mean of 100 CFU per 100 mL and a statistical threshold value (STV) of 320 CFU per 100 mL⁶. Therefore, the limit of detection (LoD) of any method for water quality monitoring should be lower than 100 CFU/100 mL, or 1 CFU/mL.

Conventional methods for detecting pathogens in water are mostly culture-based approaches and separation/filtration techniques in laboratories⁷. Although these conventional laboratory assays are still the standard methods since they are accurate and highly sensitive, they require bulky and costly instrumentation, trained personnel, and long turnaround times. A highly used test is the IDEXX Colilert, which can quantify the number of total coliform and E. coli in a single test. The IDEXX Colilert system is easy to use and does not require highly trained personnel. However, it still requires bulky and expensive equipment such as an incubator, and its long time-to-result (24 hours) for bacterial culture⁸. Therefore, there is a growing trend to develop small, easy-to-use, and cost-effective devices for on-site methods for more rapid results¹. Rapid results allow for immediate action, preventing people from contracting diseases. The development of on-site methodologies further benefits resource-limited countries or other areas where laboratory settings are not available or easily accessible.

On-site portable platforms include approaches based on enzymatic substrate assays⁹⁻¹¹, microfluidics¹²⁻¹⁴, lateral flow strips^{15, 16}, and paper-based analytical devices ^{10, 17}, coupled with fluorescence¹⁸, colorimetryl⁹, or electrochemistry²⁰ detection for rapid and easy interpretation of results. The limitations of these approaches include low sample volume processed (e.g., microfluidic devices), high LoD due to no amplification (e.g., lateral flow assays and nucleic acid hybridization techniques), and long incubation times (e.g., enzymatic substrate assays). On the other hand, nucleic acid amplification tests (NAAT) such as polymerase chain reaction (PCR) provide low LoD and faster time-to-result than culture methods, and thus, they are often the preferred methods²¹. Nevertheless, PCR approaches require sample preparation and trained personnel, while isothermal amplification techniques such as LAMP are easier to implement^{22, 23}.

### Experimental Section

### Device Design and Fabrication

As shown in FIG. 1.1, the device consists of a buffer unit, a mixing unit, a detection unit, and a waste container. The detection unit was made of a polycarbonate well layer, double-sided adhesive tape, two layers of thermoplastic films, and a chromatography paper. The container was shaped into a 2 cm×2 cm square from a 3-mm-thick polycarbonate sheet (McMaster-Carr, Elmhurst, IL) using a CNC milling machine (Sherline Products, Vista, California), and a well of 4-mm (or 6-mm) diameter was created in the center. One piece of Whatman™ 1 chromatography paper (Fisher Scientific) and two 75-μm-thick polyester thermal bonding lamination films (Lamination Plus, Kaysville, UT, USA) were cut into 3.5-mm or (5.5-mm) diameter circles using a Graphtec Craft Robo-S cutting plotter (Graphtec Corporation, Yokohama, Japan). The paper was then sandwiched between the two thermoplastic films and passed through a laminator, GBC® Catena 65 Roll Laminator (GBC, Lake Zurich, IL, USA), set at a rolling speed of “1” and at a temperature of 220° F. as previously described^{24, 25}. This laminated paper pad was then attached to the polycarbonate well layer using double-sided adhesive tape (3M 9087 white bonding tape, R. S. Hughes, Sunnyvale, CA), forming the detection unit.

A commercial 3D printer, Ultimaker 3 (Ultimaker, Geldermalsen, Netherlands) was used to fabricate the buffer unit, the mixing unit, and the waste container. The devices were printed using acrylonitrile butadiene styrene (ABS), with the print layer height set to 0.1 mm and the infill density set to 100%. The balls used for valving in each well were 4.0-mm-diameter corrosion-resistant 316 stainless steel balls (McMaster-Carr, Elmhurst, IL). To prevent accidental displacement or movement of the ball valves, a small amount of Akrowax™ 130 (Akrochem, Akron, OH, USA) was placed around the balls, heat-melted and re-solidified, forming a breakable bond between balls and the buffer unit. The valve concept is illustrated in FIG. 1.2.

The buffer unit has a cylindrical shape with a diameter of 7.1 cm, a height of 1 cm, three reservoirs with a top diameter of 2 cm, and one with 2.4 cm, all with a depth of 1 cm, and a smaller diameter of 0.38 cm. These reservoirs can hold volumes up to 1.28 and 1.78 mL, respectively. The mixing unit has height of 4.5 cm, an outside top diameter of 6.5 cm, an inside top diameter of 5.5 cm, an outside bottom diameter of 8 cm, and inside diameter of 6 cm. The wall thickness on the top is 1 cm, and 2 cm at the bottom, which helps achieve vacuum on the device without air leakage in the walls of the 3D printed material. The liquid passage of the mixing unit to the detection unit has a diameter of 5 mm for integration with the 6 mm diameter detection units, which is located 3 cm from the top of the mixing well. The waste container has an outside diameter of 10 cm, and a height of 3 cm, however, these dimensions and those of the mixing unit could be reduced if no vacuum is used, or if a device is fabricated using a different manufacturing technique. Overall, when the device is assembled, the total height is 7.5 cm.

The sample preparation process of the device consists of sequentially releasing the buffer solutions for DNA lysis, binding, and washing from the buffer unit into the mixing unit through actuation of ball-based valves. These solutions are then directed to go through the detection unit for DNA enrichment and purification onto the chromatography paper. First, all buffer solutions are loaded into their respective reservoirs in the buffer unit, including 200 μL of AL lysis buffer (QIAGEN), 200 μL of ethanol, 500 μL of AW1 (QIAGEN), and 500 μL of AW2 (QIAGEN). Secondly, 1 mL of a water sample is added to the first reservoir containing the lysis solution to lyse the sample for 10 minutes, and then the mixture is discharged to the mixing unit by rotating the buffer unit and actuating the valve. This was followed by immediately rotating the buffer unit again to discharge the binding buffer, ethanol, to mix with the sample/lysis mixture. After these solutions go through the mixing unit and then into the paper pad in the detection unit, the buffer unit is rotated again to discharge the wash buffers, AW1, and AW2, one at a time to purify the collected DNA on the paper. After DNA enrichment and purification, the detection unit is detached from the mixing unit, and prepared for DNA amplification.

Fluid-control valves are employed to perform sample preparation by sequential release of the reagents from the buffer unit into the mixing unit without the need of basic laboratory equipment. Each valve consists of a stainless-steel ball placed at the bottom of a buffer well to prevent the reagent from flowing down until it is desired. The ball protrudes 1.5 mm from the bottom of the buffer unit so that the pin in the mixing unit lifts the balls up and allows the reagents to flow down when the pin is aligned with the balls, as shown in FIG. 1.2. This valving mechanism is essentially the same as reported previously ^{24, 25}, though horizontal sliding, rather than rotation, was used in the previous work. To prevent ball displacement and leakage during transportation, a breakable wax-based bond is created between the ball and the reservoir. First, a piece of wax is heat-melted in a small beaker, followed by dipping a ball into the melted wax. The ball containing a thin layer of wax is immediately placed in the reservoir, allowing the wax to solidify and create a breakable bond to prevent any undesired movement.

### LAMP Reaction

Each 25-μL LAMP mix contains 2.5 μL of 10× isothermal amplification buffer, 8 U Bst 2.0 WarmStart® DNA polymerase, 2.5 μL of 10× concentrated primer mix, and a final concentration of 1.4 mM dNTPs and 6 mM MgSO₄. The 25-μL volume was filled up by nuclease-free water (not DEPC treated). Except for the nuclease-free water and dNTPs from ThermoFisher Scientific (MA, USA), the other reagents in the LAMP mix were obtained from New England Biolabs (NEB) (Ipswich, MA, USA). The 10× primer mix contains 16 μM FIP/BIP, 2 μM F3/B3, and 8 μM LF/LB (Table 1.1). The primers were obtained from Integrated DNA Technologies (Coralville, Iowa, USA), and their sequences were chosen by following the literature²⁶. When 50-μL LAMP mix was used to replace the 25-μL mix, the volumes of all reagents were doubled, keeping the same final concentration. To prevent non-specific amplification and possible false-positive results, UDG and dUTP were added to the LAMP reactions to eliminate carryover contamination. UDG has been widely used to prevent carryover contamination without compromising sensitivity in LAMP and other nucleic acid amplification assays²⁷⁻²⁹.

TABLE 1.1
Sequences of LAMP primers for E. coli detection targeting the malB region²⁶.

| Primer name | Primer sequence (5′ - 3′) | Bases |
|---|---|---|
| F3 (SEQ. ID# 1) | GCCATCTCCTGATGACGC | 18 |
| B3 (SEQ. ID# 2) | ATTTACCGCAGCCAGACG | 18 |
| FIP (F1c + F2) | CTGGGGCGAGGTCGTGGTATTCCGACAAACACCACGAATT | 40 |
| (SEQ. ID# 3) | | |
| BIP (B1 + B2c) | CATTTTGCAGCTGTACGCTCGCAGCCCATCATGAATGTTGC | 42 |
| (SEQ. ID# 4) | T | |
| LF (SEQ. ID# 5) | CTTTGTAACAACCTGTCATCGACA | 24 |
| LB (SEQ. ID# 6) | ATCAATCTCGATATCCATGAAGGTG | 25 |

To achieve LAMP without the need of connection to a power outlet, we chose a commercially available, battery-powered coffee mug (Ember™ Travel Mug, Ember Technologies, Inc., Westlake Village, CA) as a water bath as reported previously^{24, 25}. Prior to being placed in the Ember™ mug containing water at 62.5° C., the detection units were sealed using two pieces of tape (Fellows®) to cover the bottom and top parts to prevent leakage and evaporation. After 45 minutes of incubation, the detection units were taken out for colorimetric detection, which was carried out by adding 1.0 μL of 10,000× concentrate SYBR green I in dimethyl sulfoxide (ThermoFisher Scientific) to each detection unit. We used SYBR green, a fluorescent dye, for colorimetric detection of amplicons; the color change can be visualized by the naked eye or recorded using a smartphone camera. To help visualization, an ULAKO blue LED flashlight (Amazon, WA, USA) powered by one AA battery was used to observe the green fluorescence when E. coli were present. The results can also be verified by gel electrophoresis. Note that LAMP produces a range of amplicons with different sizes; hence it does not have one specific gel band as with PCR³⁰.

### LAMP Time and Sensitivity

To study the incubation time required for the LAMP assay, real-time LAMP experiments were carried out by adding 0.5 μL of 10× concentrate SYBR green I (ThermoFisher Scientific) to the 25-μL LAMP reaction mix. The fluorescence signal from the LAMP reaction was read through the QuantStudio 3 real-time PCR system (ThermoFisher Scientific). For each experiment, we tested 4 different E. coli DNA concentrations, 8×10⁴, 8×10³, 8×10², and 8×10¹ genome equivalents (GEs) spiked into 25-μL reactions. We tested 3 replicates of each concentration including 3 no-template controls (NTCs).

To assess the limit of detection (LoD) of the LAMP assay for detection of E. coli, DNA was extracted from E. coli DH5-α cells using the QIAamp DNA Mini Kit (QIAGEN). The concentration of the purified DNA was determined to be 160 ng/μL using an ultraviolet-visible spectrophotometer. The GEs/μL of the extracted DNA were calculated, which were determined to be approximately 3×10⁷ GEs/μL using the molecular weight of E. coli genome. Serial dilutions of this stock solution were made using nuclease free water (Fisher Scientific). 1 μL of purified DNA of the different concentrations was added into 25-μL LAMP reactions, along with an NTC.

The number of genome equivalents were calculated based on the number of base pairs in the sequence, which was determined from NCBI GenBank (CP026085.1), which is 4,833,062 base pairs. Then, using the Equation 1 below³¹, we calculated the number of genome equivalents of the purified DNA.

$$Genome equivalents = \frac{ng of double stranded DNA \times Avogadro ' s constant}{number of base pairs \times {10}^{9} \times 650 Daltons} = 30,670,793 \qquad ( 1 )$$

### Water Sample Testing

Environmental water samples were collected in the northeast Florida region, at the Pellicer Creek (29.66260N 81.26837W), Mouth of Pellicer Creek (29.66431N 81.22892 W), and the Whitney Lab Docks (29.669249N 81.216506W). Sample #1 was collected from the Whitney Lab Docks on Aug. 30, 2019, while sample #2 was collected from the Mouth of Pellicer Creek on Sep. 6, 2019. Both were filtered using a Whatman glass fiber filter and a peristaltic pump. Samples #3 and #4 (three replicates) were collected at the Pellicer Creek and the Whitney Lab Docks, respectively, on May 26, 2021. A summary of the environmental samples' information is given in Table 1.2. These samples #3 and #4 were given unfiltered and blinded to the researcher who performed the experiments to validate the platform. Some of samples #3 and #4 were filtered using a Whatman glass fiber filter (0.7 μm) and a 50 ml syringe, and the assay performance was compared between filtered and unfiltered samples. All water samples were processed using the device with the protocol described above.

TABLE 1.2
Environmental water samples information

| Water | # | | Collection |
|---|---|---|---|
| Samples | Replicates | Location | Date |
| #1 | 1 | Whitney Lab Docks | Aug. 30, 2019 |
| | | (29.669249 N 81.216506 W) | |
| #2 | 1 | Mouth of Pellicer Creek | Sep. 6, 2019 |
| | | (29.66431 N 81.22892 W) | |
| #3 | 3 | Pellicer Creek | May 26, 2021 |
| | | (29.66260 N 81.26837 W) | |
| #4 | 3 | Whitney Lab Docks | May 26, 2021 |
| | | (29.669249 N 81.216506 W) | |

### Effects of Salinity

To study the possible effects of the salt in ocean water on sample preparation and LAMP assay and demonstrate the capability of our platform to process a wide variety of water samples, we spiked E. coli DH5-α cells into distilled water samples containing 3.5%, 2.0%, 0.5%, and 0.0% weight percentage of sodium chloride (NaCl). These concentrations were chosen to simulate the concentration of salt in water from oceans (3.5%) to fresh water (˜0%). Any concentration between them can be found in water at different points of the estuaries. Five replicates were tested for each salt concentration. To prepare the samples, a random number of E. coli DH5-α cells from a suspension media were added to a 2-mL tube, centrifuged to form a cell pellet, and removed the culture media. The cell pellet was resuspended in 0.4 mL DI water, mixed by pulse-vortexing, and then divided into four 2-mL tubes. Then, these tubes were centrifuged again, and the DI water was discarded. Finally, 1 mL of the water containing one type of salt concentration was added to each tube containing the E. coli cells at the bottom.

### Results and Discussion

### Device Design and Fabrication

FIG. 1.1 shows the design of the device for DNA extraction, enrichment, purification, and detection of E. coli in environmental water samples. The device consists of a buffer unit in the top, a mixing unit in the middle, a detection unit inserted on the bottom side of the mixing unit, and a waste container. The buffer unit contains the reagents needed for sample preparation, which are discharged by rotating the buffer unit over the mixing unit to actuate the ball-based valves. These ball-based valves function as fluid-control valves by preventing the reagents from going down until the balls are lifted by the pin in the mixing unit. These reagents then mix and go through the detection unit for collection of purified DNA onto the chromatography paper, which is then used for amplification via LAMP.

Our device integrates all the necessary steps for a nucleic acid assay, including lysis, DNA enrichment and purification, amplification, and detection. As a result, our platform eliminates the need for sample transportation from the real world to a lab. It also has much shorter assay time than culture-based approaches. Compared with traditional sample preparation methods based on solid extraction columns, the DNA enrichment process onto a paper pad further reduces steps where DNA would be transferred between tubes, avoiding possible contamination and degradation issues, and eliminating any elution step to extract the DNA from the solid column. The DNA in the paper pad in our device was directly used in LAMP, which has a significant advantage because not all the DNA on the paper can be eluted, and the purified DNA is diluted if elution is implemented. An untreated, cellulose chromatography paper was chosen for DNA enrichment after comparison with FTA card, showing similar results demonstrated with influenza viruses³².

### Effects of Paper Size

To optimize the paper size in the detection unit, we carried out the following analysis. We calculated the sample preparation time using Equation 2. The volume of the sample is 1 mL, while the total volume of the reagents of lysis/binding/wash buffers is 1.4 mL. The flow velocity is 4.33 mm/min according to the manufacturer of the chromatography paper. The surface area of the paper circle was calculated from its diameter. Our calculation results are shown in FIGS. 1.6A-1.6B. We observed that after a certain paper size, the decrease in sample preparation time was not significant. At the same time, when the diameter of the paper circle increases, the volume of LAMP mix required to cover the whole area increases proportionally with the surface area (or square of diameter). Since the volume of the LAMP mix is 25 μL in a 4-mm well as we previously reported^{24, 25}, the volume of LAMP mix required for other paper circle size can be calculated using Equation 3. The results are plotted in FIG. 1.6B, and they indicate that the volume, and accordingly the cost of the LAMP mix, increases considerably. As a result, we chose a paper size of 6-mm diameter, and a LAMP mix volume of 50 μL for experimental comparison.

$$time ( min ) = \frac{Volume of ( sample + reagents )}{Flow velocity * Surface area} \qquad ( 2 )$$

$$LAMP volume = 25 µL * \frac{{D}^{2}}{{4}^{2}} \qquad ( 3 )$$

We used water samples #1 and #2 to compare the sample preparation time between the 4-mm and the 6-mm diameter paper pads. We saw a large difference as summarized in Table 1.3. The samples took over 131 min to process using the 4-mm diameter papers, whereas they took 23 min for the 6-mm diameter papers. These results confirmed the much better performance of the larger paper size for our device. We also compared the sample preparation time of different types of samples using the 6-mm diameter papers, unfiltered water samples, and distilled water samples spiked with salts for the salinity experiments. We observed that the time decreased about 8 min from the unfiltered samples to filtered samples, and it was further reduced about 4 minutes from the filtered samples to the spiked ones. Their average preparation times were 31, 23, and 19 minutes, respectively. The results are also summarized in Table 1.3.

TABLE 1.3
Average experimental sample preparation time for each type
of sample and paper size with one standard deviation.

| Paper diameter | 6 mm | | | 4 mm |
|---|---|---|---|---|
| Type of sample | unfiltered | filtered | spiked | filtered |
| Time (min) | 31.22 ± | 22.78 ± | 19.39 ± | 131.25 ± |
| | 9.99 | 5.45 | 5.71 | 55.49 |

### LAMP Time and Sensitivity

We employed a real-time PCR machine to identify the minimum time required for LAMP assay. FIG. 1.3A shows the average fluorescence amplification curves for 4 different DNA concentrations, using 3 replicates for each curve. All the samples crossed the threshold line (defined as 10 times the standard deviation of the background noise above the background) within 35 minutes, and reached a plateau within 45 minutes. As a result, we chose 45 minutes as the LAMP reaction time. All reactions in FIGS. 1.3A and 1.3B were incubated for 60 min, and no non-specific amplification was observed in all replicates of NTCs. Since LAMP involves many complex steps, the fluorescence signal is not correlated with the starting bacteria amount. However, the threshold time can be used to correlate with the initial amount of bacteria, as in PCR³³. FIG. 1.3B shows the calibration curve between the threshold time and bacterial amount, indicating that semi-quantitative E. coli detection is feasible.

Other approaches, such as those based on enzymatic substrate assays also offer a high sensitivity and are capable of processing large sample volumes, however, they have long turnaround times between 4 to 12 hours of incubation, which depends on the concentration of the samples⁹⁻¹¹. Nucleic acid amplification assays combine both qualities: rapid detection and high sensitivity. X. Lin et al. developed an asymmetric membrane to process up to 10 mL water samples combined with digital LAMP in the micropores of the membrane capable of detecting E. coli as low as 0.3 cells/mL within one hour²². However, they require laboratory equipment for amplification and detection. Although the hot plate for amplification could be easy to implement in the field, they require a fluorescence microscope and an image processing software for later analysis of the results²²

We studied the limit of detection of the LAMP assay using 300, 30, 3, and 1 GEs of E. coli DH5-α DNA and observed the positive signals in all 5 replicates of 300, 30, and 3 GEs as shown in FIGS. 1.4A-1.4C. However, for 1 GE samples, we observed positive signals in only 1 out of 3 replicates, indicating the LoD of our assay is at 3 GEs. The results were confirmed using gel electrophoresis (FIG. 1.4A-1.4C).

### Environmental Water Samples

We first tested the filtered water samples #1 and #2, whose total coliform were measured using the IDEXX Colilert system, and were 517.2 CFU/100 mL, and 270 CFU/100 mL, respectively. Note that total coliform is a large collection of different types of bacteria, including E. coli as well as many others. Therefore, it does not necessarily correlate with the number of E. coli. After testing each sample five times, we were able to get positive results for all five tests of sample #1, and four out of those five tests of sample #2, as shown in Table 1.4. FIGS. 1.8A-1.8B show the results of 3 replicates for each sample.

TABLE 1.4
Summary of results of the environmental water samples collected
from the Whitney Lab docks (sample #1) and Mouth Pellicer
Creek (sample #2), and their comparison to the number
of total coliforms measured using the IDEXX Colilert test.

| Sample | Positive tests* | Total Coliforms |
|---|---|---|
| #1 | 5/5 | 517.2 CFU/100 mL |
| #2 | 4/5 | 270 CFU/100 mL |

Note:
*the results are listed as the number of positive results/the number of experiments.

Since there was no information about the number of E. coli in those samples, we collected more samples from similar locations, three sample replicates from the Whitney Lab Docks (sample #4), and another three from the Pellicer Creek (sample #3). After measuring the number of total coliforms and E. coli using the IDEXX Colilert system, these replicates were given blinded to the researchers that performed the experiments with the device reported here. First, each sample replicate was tested 2 times, and we got positive results for all 6 tests from the sample #4 replicates, and only 2 out of 6 of the sample #3 replicates, 1/2 for replicates #1 and 2, and 0/2 for replicate #3. To get more accurate data, we tested each replicate from the sample #3 one more time, and got positive results for replicates #1 and 2, and negative for replicate #3.

However, after the total coliform and E. coli information was given for each replicate, the data did not exactly correlate with our results, as seen in Table 1.5, where the sample #3 replicates had larger E. coli number than the sample #4 replicates. During these experiments, it was noted that all the sample #3 replicates, especially replicate #3, left numerous dark particles on the papers of the detection units. Thus, to verify if this could have inhibited some of the LAMP reactions, we filtered all the samples using 0.7 μm Whatman glass fiber filters to eliminate the particulate material from each replicate, while allowing most bacteria to pass through the filter. Then, we tested the filtered samples along with the unfiltered ones for comparison, and some of the results are shown in FIGS. 1.5A and 1.5B, and all the results are given in Table 1.5. FIGS. 1.5A and 1.5B show the results of the Pellicer Creek replicates, where the top row are the unfiltered samples, and the bottom row are the filtered ones, placed in order from left to right in ascending order. FIGS. 1.5C and 1.5D show the results of the Whitney Lab Docks replicates, where the top row are the unfiltered samples, and the bottom row are the filtered ones, placed in order from left to right in ascending order. FIGS. 1.5A and 1.5C are taken under room light, and FIGS. 1.5B and 1.5D are taken under a blue LED and a yellow filter to enhance the fluorescence signal of the positive results.

TABLE 1.5
Summary of results of the blind water samples #3 and 4, comparing before and after filtration,
and their results for total coliforms and E. coli using an IDEXX Colilert test.

| | SAMPLE # | | | | | | | | | | | |
|---|---|---|---|---|---|---|---|---|---|---|---|---|
| | SAMPLE #3 | | | | | | SAMPLE #4 | | | | | |
| Replicate # | 1 | | 2 | | 3 | | 1 | | 2 | | 3 | |
| Total Coliforms | >2419.6 | | >2419.6 | | >2419.6 | | 20 | | 20 | | 40 | |
| (CFU/100 mL) | | | | | | | | | | | | |
| E. Coli | 435.2 | | 275.5 | | 224.7 | | <20 | | <20 | | 20 | |
| (CFU/100 mL) | | | | | | | | | | | | |
| Filtered (F)/ | U | F | U | F | U | F | U | F | U | F | U | F |
| Unfiltered (U) | | | | | | | | | | | | |
| Positive tests* | 4/6 | 3/3 | 5/6 | 3/3 | 0/6 | 3/3 | 3/4 | 3/3 | 4/4 | 2/3 | 4/4 | 3/3 |

| | | | | |
|---|---|---|---|---|
| Total per sample | 9/18 (U) | 9/9 (F) | 11/12 (U) | 8/9 (F) |

*The results are listed as the number of positive results/the number of experiments.

These results suggest that those particles found in sample #3 replicates inhibited the LAMP reaction afterwards, and that adding a filtration step prior to testing eliminates the issue. On the other hand, as seen with the sample #4 replicates, it did not seem to reduce sensitivity, as for both cases, filtered and unfiltered, we got positive results for all the tests except for one. For these reasons, it would be recommended to add a filtration step prior to processing the sample in our device when available to prevent possible inhibition effects, although it is not necessary if the samples contain low particulate material.

### Effects of Salinity

To address the concern of possible effects of ocean water on the LAMP assay, we performed experiments testing various salt concentrations spiked in water that contained similar number of E. coli cells. The concentration of salt ranged from 0 to 3.5%, which is the same as ocean water. For each salt concentration we tested 5 replicates. For salt concentrations <3.5%, there were positive results in 4 out of 5 tests, while the highest salt concentration, 3.5%, had positive results in all 5 tests. Table 1.6 shows the summary of results, and FIGS. 1.7A-1.7B shows an example of the results of the experiments. With these results, we believe that salt concentration does not have a significant effect in either the sample preparation or the LAMP reaction. The replicates that we did not detect of the lower salt concentration samples could have occurred due to human error, leakage in the device, improper mixing or distribution of particles, or other reasons.

TABLE 1.6
Summary of results for the spiked samples
with different weight salt concentrations.

| Weight salt concentration | 3.5% | 2.0% | 0.5% | 0.0% |
|---|---|---|---|---|
| Positive tests* | 5/5 | 4/5 | 4/5 | 4/5 |

*The results are listed as the number of positive results/the number of experiments.

Nevertheless, the higher salt concentration might help during the sample preparation process, as it has been reported before that DNA extraction efficiency increases in higher salt concentration buffers for silica-based protocols, without affecting the subsequent nucleic acid amplification assay thanks to the washing buffers³⁸. This is also supported by the results from the environmental water samples, where we got very good results from all the samples tested from the Whitney Lab Docks (samples #1 and 4), which are the samples with the highest salt concentration tested, in comparison with the results from the Mouth of Pellicer Creek (sample #2) or the Pellicer Creek (sample #3).

### Limit of Detection

The overall platform also showed good sensitivity, as we were able to consistently detect E. coli from the replicate #3 of the sample #4, that contained 20 CFU/100 mL as detected by the IDEXX Colilert system, and thus, a LoD of at least 0.2 CFU, as we used 1 mL samples. Therefore, the limit of detection of the platform is at least five times lower than the threshold limit suggested by the US EPA which was 100 CFU/100 mL⁶.

Compared to other portable platforms for detection of E. coli or other coliforms in water, our platform offers higher sensitivity compared to lateral flow assays and other immunoassays, whose limit of detection is not sufficient to detect concentrations below 100 CFU/100 mL, the threshold limit recommended by the US EPA, as their limit of detection is generally higher than 50 CFU/mL^{34, 35}. Other microfluidic approaches, although offer a low limit of detection, they still offer lower sensitivity due to the lower sample volume process^{36, 37}, which is generally just a few microliters, so even if they can detect a single cell, their overall sensitivity is not sufficient to detect lower concentrations than 100 CFU/100 mL.

### CONCLUSION

We have developed an on-site testing platform for E. coli detection in environmental water samples. Contrary to most platforms, the sample preparation is included in our platform, which requires simple steps of (1) rotating the buffer unit, (2) waiting for reagents to mix and go through the paper pad, and (3) removing the paper-based detection unit for subsequent amplification step. Amplification of the collected DNA is achieved by immersing the detection unit inside a coffee mug at a constant temperature. The results can be visualized by the naked eye, or a smartphone camera based on color change. Our platform offers low LoD, and it is easy-to-use and portable for on-site testing. Additionally, this platform can be easily adapted to detect other pathogens by simply modifying the target organism in the LAMP assay.

To our knowledge, our on-site testing platform is the first portable platform that can detect E. coli below the threshold limit of 100 CFU/100 mL using NAAT integrating all the necessary steps including sample preparation, DNA amplification, and detection into a single platform without the need of bulky or sophisticated laboratory equipment, in just over an hour. Other platforms have been reported for detection of E. coli or other coliforms using NAAT but require sophisticated equipment for detection^{22, 37}. Other methods that are fast and offer low LoD, are not able to process large enough samples for adequate sensitivity^{22, 36}. Enzymatic substrate assays for E. coli detection have great sensitivity and are easy-to-use, but they have much longer turnaround times⁹⁻¹¹. Lateral flow assays or other immunoassays are very rapid and easy-to-use, but lack sensitivity ^{34-36, 39}.

The reagents in our platform can be pre-packaged in the buffer unit for storage and transportation for on-site testing, and the ball-based valves have shown no leakage for several weeks when wax is used to fix the ball to the respective reservoir. The LAMP mix can also be pre-loaded in disposable pipettes and stored in ice coolers. Another alternative is to use lyophilized RT-LAMP reagents as reported elsewhere^{40, 41}. Therefore, our platform can be used in the field, helping reduce infection by water quality monitoring on the spot.

### Example 1 References

1. Kumar, S.; Nehra, M.; Mehta, J.; Dilbaghi, N.; Marrazza, G.; Kaushik, A., Point-of-Care Strategies for Detection of Waterborne Pathogens. Sensors (Basel) 2019, 19 (20).
2. Payment, P., Epidemiology of endemic gastrointestinal and respiratory diseases: incidence, fraction attributable to tap water and costs to society. Health-Related Water Microbiology 1996 1997, 35 (11), 7-10.
3. Pandey, P. K.; Kass, P. H.; Soupir, M. L.; Biswas, S.; Singh, V. P., Contamination of water resources by pathogenic bacteria. AMB Express 2014, 4, 51.
4. Proce, R. G.; Wildeboer, D., E. coli as an Indicator of Contamination and Health Risk in Environmental Waters. In Escherichia coli—Recent Advances on Physiology, Pathogenesis and Biotechnological Applications, Samie, A., Ed. Intechopen: 2017.
5. Odonkor, S. T.; Ampofo, J. K., Escherichia coli as an indicator of bacteriological quality of water: an overview. Microbiology Research 2013, 4 (1), e2.
6. USEPA FAQ: NPDES Water-Quality Based Permit Limits for Recreational Water Quality Criteria; USEPA: 2015.
7. Van Nevel, S.; Koetzsch, S.; Proctor, C. R.; Besmer, M. D.; Prest, E. I.; Vrouwenvelder, J. S.; Knezev, A.; Boon, N.; Hammes, F., Flow cytometric bacterial cell counts challenge conventional heterotrophic plate counts for routine microbiological drinking water monitoring. Water Res 2017, 113, 191-206.
8. Yakub, G. P.; Castric, D. A.; Stadterman-Knauer, K. L.; Tobin, M. J.; Blazina, M.; Heineman, T. N.; Yee, G. Y.; Frazier, L., Evaluation of Colilert and Enterolert defined substrate methodology for wastewater applications. Water Environ Res 2002, 74 (2), 131-5.
9. Angelescu, D. E.; Huynh, V.; Hausot, A.; Yalkin, G.; Plet, V.; Mouchel, J. M.; Guérin-Rechdaoui, S.; Azimi, S.; Rocher, V., Autonomous system for rapid field quantification of Escherichia coli in surface waters. J Appl Microbiol 2019, 126 (1), 332-343.
10. Burnham, S.; Hu, J.; Anany, H.; Brovko, L.; Deiss, F.; Derda, R.; Griffiths, M. W., Towards rapid on-site phage-mediated detection of generic Escherichia coli in water using luminescent and visual readout. Anal Bioanal Chem 2014, 406 (23), 5685-93.
11. Hossain, S. M.; Ozimok, C.; Sicard, C.; Aguirre, S. D.; Ali, M. M.; Li, Y.; Brennan, J. D., Multiplexed paper test strip for quantitative bacterial detection. Anal Bioanal Chem 2012, 403 (6), 1567-76.
12. Almeida, M. I. G. S.; Jayawardane, B. M.; Kolev, S. D.; McKelvie, I. D., Developments of microfluidic paper-based analytical devices (μPADs) for water analysis: A review. Talanta 2018, 177, 176-190.
13. Kaneta, T.; Alahmad, W.; Varanusupakul, P., Microfluidic paper-based analytical devices with instrument-free detection and miniaturized portable detectors. Applied Spectroscopy Reviews 2019, 54 (2), 117-141.
14. Nasseri, B.; Soleimani, N.; Rabiee, N.; Kalbasi, A.; Karimi, M.; Hamblin, M. R., Point-of-care microfluidic devices for pathogen detection. Biosens Bioelectron 2018, 117, 112-128.
15. Melnik, S.; Neumann, A. C.; Karongo, R.; Dirndorfer, S.; Stubler, M.; Ibl, V.; Niessner, R.; Knopp, D.; Stoger, E., Cloning and plant-based production of antibody MC10E7 for a lateral flow immunoassay to detect [4-arginine]microcystin in freshwater. Plant Biotechnol J 2018, 16 (1), 27-38.
16. Akter, S.; Kustila, T.; Leivo, J.; Muralitharan, G.; Vehniainen, M.; Lamminmäki, U., Noncompetitive Chromogenic Lateral-Flow Immunoassay for Simultaneous Detection of Microcystins and Nodularin. Biosensors (Basel) 2019, 9 (2).
17. Choi, J.; Yong, K.; Tang, R.; Gong, Y.; Wen, T.; Li, F.; Pingguan-Murphy, B.; Bai, D.; Xu, F., Advances and challenges of fully integrated paper-based point-of-care nucleic acid testing. Trac-Trends in Analytical Chemistry 2017, 93, 37-50.
18. Taitt, C. R.; Anderson, G. P.; Ligler, F. S., Evanescent wave fluorescence biosensors: Advances of the last decade. Biosens Bioelectron 2016, 76, 103-12.
19. Kudo, H.; Yamada, K.; Watanabe, D.; Suzuki, K.; Citterio, D., Paper-Based Analytical Device for Zinc Ion Quantification in Water Samples with Power-Free Analyte Concentration. Micromachines 2017, 8 (4), 127.
20. Mettakoonpitak, J.; Boehle, K.; Nantaphol, S.; Teengam, P.; Adkins, J. A.; Srisa-Art, M.; Henry, C. S., Electrochemistry on Paper-based Analytical Devices: A Review. Electroanalysis 2016, 28 (7), 1420-1436.
21. Mendes Silva, D.; Domingues, L., On the track for an efficient detection of Escherichia coli in water: A review on PCR-based methods. Ecotoxicol Environ Saf 2015, 113, 400-11.
22. Lin, X.; Huang, X.; Zhu, Y.; Urmann, K.; Xie, X.; Hoffmann, M. R., Asymmetric Membrane for Digital Detection of Single Bacteria in Milliliters of Complex Water Samples. ACS Nano 2018, 12 (10), 10281-10290.
23. Phaneuf, C. R.; Mangadu, B.; Tran, H. M.; Light, Y. K.; Sinha, A.; Charbonier, F. W.; Eckles, T. P.; Singh, A. K.; Koh, C. Y., Integrated LAMP and immunoassay platform for diarrheal disease detection. Biosens Bioelectron 2018, 120, 93-101.
24. Jiang, X.; Loeb, J. C.; Manzanas, C.; Lednicky, J. A.; Fan, Z. H., Valve-Enabled Sample Preparation and RNA Amplification in a Coffee Mug for Zika Virus Detection. Angewandte Chemie International Edition 2018, 57 (52), 17211-17214.
25. Manzanas, C.; Alam, M. M.; Loeb, J. C.; Lednicky, J. A.; Wu, C. Y.; Fan, Z. H., A Valve-Enabled Sample Preparation Device with Isothermal Amplification for Multiplexed Virus Detection at the Point-of-Care. ACS Sens 2021, 6 (11), 4176-4184.
26. Hill, J.; Beriwal, S.; Chandra, I.; Paul, V. K.; Kapil, A.; Singh, T.; Wadowsky, R. M.; Singh, V.; Goyal, A.; Jahnukainen, T.; Johnson, J. R.; Tarr, P. I.; Vats, A., Loop-mediated isothermal amplification assay for rapid detection of common strains of Escherichia coli. J Clin Microbiol 2008, 46 (8), 2800-4.
27. Longo, M. C.; Berninger, M. S.; Hartley, J. L., Use of uracil DNA glycosylase to control carry-over contamination in polymerase chain reactions. Gene 1990, 93 (1), 125-8.
28. Hsieh, K.; Mage, P. L.; Csordas, A. T.; Eisenstein, M.; Soh, H. T., Simultaneous elimination of carryover contamination and detection of DNA with uracil-DNA-glycosylase-supplemented loop-mediated isothermal amplification (UDG-LAMP). Chem Commun (Camb) 2014, 50 (28), 3747-9.
29. Lamb, L. E.; Bartolone, S. N.; Ward, E.; Chancellor, M. B., Rapid detection of novel coronavirus/Severe Acute Respiratory Syndrome Coronavirus 2 (SARS-CoV-2) by reverse transcription-loop-mediated isothermal amplification. PLoS One 2020, 15 (6), e0234682.
30. Notomi, T.; Okayama, H.; Masubuchi, H.; Yonekawa, T.; Watanabe, K.; Amino, N.; Hase, T., Loop-mediated isothermal amplification of DNA. Nucleic Acids Res 2000, 28 (12), E63.
31. Hardinge, P.; Murray, J. A. H., Reduced False Positives and Improved Reporting of Loop-Mediated Isothermal Amplification using Quenched Fluorescent Primers. Sci Rep 2019, 9 (1), 7400.
32. Jiang, X.; Loeb, J. C.; Pan, M.; Tilly, T. B.; Eiguren-Fernandez, A.; Lednicky, J. A.; Wu, C.-Y.; Fan, Z. H., Integration of Sample Preparation with RNA-Amplification in a Hand-Held Device for Airborne Virus Detection. Analytica Chimica Acta 2021, 338542.
33. Nguyen, D.; Nguyen, V.; Seo, T., Quantification of Colorimetric Loop-mediated Isothermal Amplification Process. Biochip Journal 2019, 13 (2), 158-164.
34. Gunda, N. S. K.; Dasgupta, S.; Mitra, S. K., DipTest: A litmus test for E. coli detection in water. PLoS One 2017, 12 (9), e0183234.
35. Ma, S.; Tang, Y.; Liu, J.; Wu, J., Visible paper chip immunoassay for rapid determination of bacteria in water distribution system. Talanta 2014, 120, 135-40.
36. Park, T. S.; Yoon, J., Smartphone Detection of Escherichia coli From Field Water Samples on Paper Microfluidics. IEEE Sensors Journal 2015, 15 (3), 1902-1907.
37. Ramalingam, N.; Rui, Z.; Liu, H.; Dai, C.; Kaushik, R.; Ratnaharika, B.; Gong, H., Real-time PCR-based microfluidic array chip for simultaneous detection of multiple waterborne pathogens. Sensors and Actuators B-Chemical 2010, 145 (1), 543-552.
38. Kim, J.; Gale, B. K., Quantitative and qualitative analysis of a microfluidic DNA extraction system using a nanoporous AlO(x) membrane. Lab Chip 2008, 8 (9), 1516-23.
39. Altintas, Z.; Akgun, M.; Kokturk, G.; Uludag, Y., A fully automated microfluidic-based electrochemical sensor for real-time bacteria detection. Biosens Bioelectron 2018, 100, 541-548.
40. Toppings, N. B.; Mohon, A. N.; Lee, Y.; Kumar, H.; Lee, D.; Kapoor, R.; Singh, G.; Oberding, L.; Abdullah, O.; Kim, K.; Berenger, B. M.; Pillai, D. R., A rapid near-patient detection system for SARS-CoV-2 using saliva. Sci Rep 2021, 11 (1), 13378.
41. Juscamayta-Lopez, E.; Valdivia, F.; Horna, H.; Tarazona, D.; Linares, L.; Rojas, N.; Huaringa, M., A Multiplex and Colorimetric Reverse Transcription Loop-Mediated Isothermal Amplification Assay for Sensitive and Rapid Detection of Novel SARS-CoV-2. Front Cell Infect Microbiol 2021, 11, 653616.

### Example 2

Harmful algal blooms (HAB) occur when algae grow out of control and cause ecological and economic harm. Along the Florida Gulf Coast, red tides are common HAB caused by the reproduction of Karenia brevis, a species of dinoflagellate. K. brevis contains brevetoxins that can sicken or kill fish, turtles, and marine mammals. These toxins can also affect humans, causing shellfish poisoning or respiratory irritation.

Although it is difficult to control red tides, it is possible to forecast their movement once located. Monitoring the movement and level of red tides is important because of their effects on marine life and human. Forecasting and the tracking information is valuable for policymakers to allow timely warning to the public and permit beachgoers to make informed decisions.

Currently, water samples are routinely collected and the concentration of K. brevis in these samples is measured microscopically in laboratories. It is desirable to have a hand-held device that is easy to operate and able to rapidly detect K. brevis in the field or on a ship. This example will address this need.

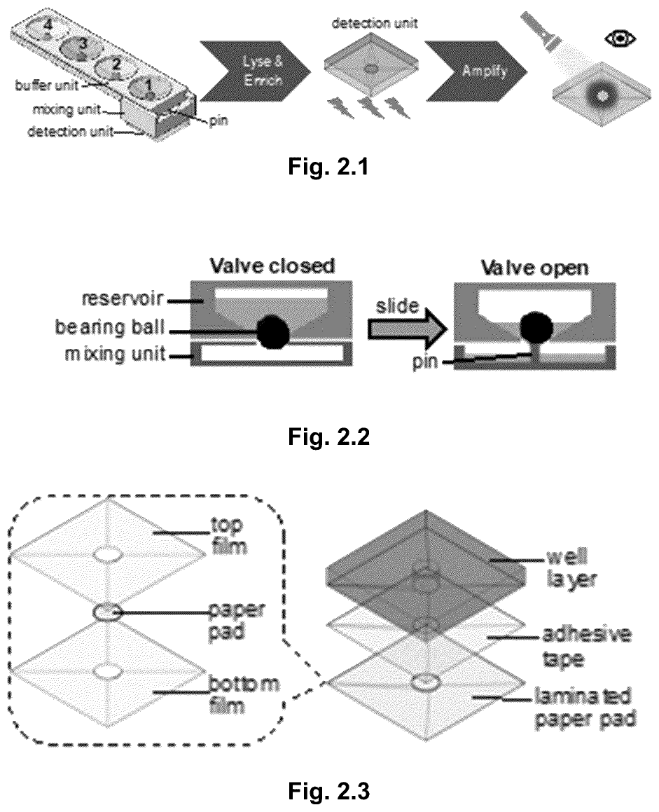

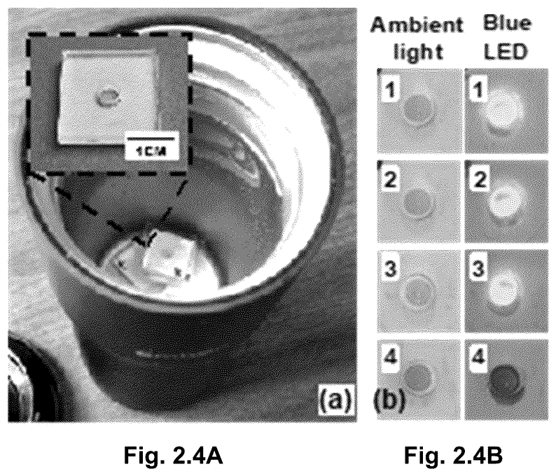

We can use either the device described herein or previously disclosed device called Valve-enabled Lysis, paper-based DNA Enrichment, and DNA Amplification Device (VLEAD) (see PCT/US2022/076456) for K. brevis detection. VLEAD integrates sample preparation—including cell lysis and DNA enrichment—with loop-mediated isothermal amplification (LAMP) for accurate genetic identification. The sample preparation steps such as lysis and washing do not need basic lab equipment such as a pipette, and colorimetric detection is used for the sample-to-answer identification. FIG. 2.1 shows the process flow and the schematic of the VLEAD device, which contains three parts: a buffer unit (top layer), a mixing unit, and a detection unit. The buffer unit is made using 3D-printing. The mixing unit is integrated with the detection unit by inserting the bottom protrusion of the mixing unit into the center well of the detection unit. The detection unit consists of a polycarbonate sheet with a well in the center and a laminated paper pad.

To detect K. brevis, a lysis solution (reservoir #1 in the buffer unit in FIG. 2.1), binding buffer (reservoir #2), and two types of washing buffers (reservoirs #3 and #4) are pre-packaged into their designated reservoirs in the buffer unit. A ball valve concept (explained in FIG. 2.2) is employed to conduct cell lysis and DNA extraction without the need of pipetting. The buffer unit is slid into the mixing unit through the sliding slots on the edges of the buffer unit. After introducing a sample into the mixing unit, the solution in reservoir #1 is discharged through the first ball valve by sliding the unit, followed by the discharge of binding buffer in reservoir #2 in the same manner. The binding buffer facilitates the absorption of DNA onto the paper pad in the detection unit (FIG. 2.3). Note that all DNA in the sample is concentrated on the paper pad while all solutions flow through. An adsorption pad underneath (not shown in FIG. 2.1) functions as the waste absorber just like the absorption pad at the end of a pregnancy test strip. Following DNA enrichment, the mixing unit slide again to allow two types of wash buffers in reservoirs #3 and #4 to be released into the mixing unit. These steps will purify DNA collected on the paper pad.

FIG. 2.2 shows a fluid control valve to trigger the reagent release from the buffer unit to the mixing unit. The valve is inspired by the design of a ballpoint pen, in which ink is dispensed onto paper when the metal ball at the tip is pressed while writing. An opening is designed at the bottom of each funnel-shaped reservoir to hold a stainless-steel ball (shown 3D in FIG. 2.1 and in 2D in FIG. 2.2). The ball keeps the buffer from flowing out of the reservoir, until it is pushed up by a pin in the mixing unit when the mixing unit is sliding along the buffer unit.

Note that the funnel-shaped reservoirs in FIGS. 2.1 and 2.2 are designed to process a larger sample volume, allowing enrichment of DNA onto the paper pad when the sample flows through. FIG. 2.3 shows an exploded view of the laminated paper pad on the left and its formation of the detection unit with a well in a plastic sheet on the right. The lamination process is in a way similar to making a driving license. Note that a void is created in the center of each lamination film. The void is slightly smaller than the paper pad to allow the paper pad sealed at its rim while the rest of the paper pad is accessible.

Afterwards, the enriched DNA in the detection unit can be amplified directly without further elution. A mixture of LAMP amplification reagents is added into the well of the detection unit, followed by sealing it using a PCR tape. The sealed device is incubated for 25 min in a coffee mug for LAMP, as shown in FIG. 2.4A.

A commercially available, battery-powered Ember™ coffee mug can maintain the water temperature inside at 62.5° C. for a couple of hours, and its temperature can be accurately controlled using a smartphone App. Using the mug as a water bath for reverse transcription LAMP (RT-LAMP), we successfully detected 1, 0.5, 0.1 PFU (plaque-forming units) of Zika virus (ZIKV) in human urine samples using VLEAD as we previously reported.¹ For detection by naked eye, we used SYBR green dye and a blue LED flashlight (FIG. 2.1) to get an explicit fluorescence signal when virus is present. The test result can also be captured using a smartphone camera (FIG. 2.4B). A negative control was included in each test to prevent false positives. Note that ZIKV contain RNA, thus we performed RT-LAMP (though direct LAMP for K. brevis). This preliminary result shows the feasibility of the platform for detecting K. brevis on the spot.

The most common methods for detecting K. brevis in collected water samples include microscopy, pigment analysis or polymerase chain reactions (PCR). One disadvantage of PCR method is the requirement of sample preparation steps such as cell lysis, which are generally carried out in a laboratory before performing PCR. To address this shortcoming, several portable apparatuses have been developed, including the Biomeme thermocycler. Nevertheless, VLEAD offers substantial advantages over these detection systems as compared in Table 2.1. VLEAD differs from both the standard method (PCR) in the lab or Biomeme thermocycler due to the use of isothermal amplification, which reduces thermal management requirements and shortens assay time. We will use LAMP that has a signal amplification mechanism so that it does not suffer the sensitivity challenge often encountered in a typical isothermal amplification method. Although Biomeme thermocycler can be operated outside a lab, it still requires reagent transfers for lysis and DNA purification by using pumps² or disposable pipettes. The innovative valving mechanism in VLEAD enables the elimination of pipetting requirement. VLEAD also incorporates a sample enrichment step, which lowers the detection limit by 10-fold as demonstrated in our previous study for ZIKV detection.¹ This enrichment effect has been confirmed by comparing two sets of samples with different ZIKV concentrations using VLEAD. In terms of assay time, LAMP is much faster (˜25 min) than PCR (˜2 hr).¹ Real time PCR enables Biomeme to reduce the test time to 30-60 min.

TABLE 2.1
Testing method comparison

| | Lab | Portable | Proposed |
|---|---|---|---|
| | equipment | apparatus | research |
| Platform | COBAS ® | Frankin ™ | VLEAD |
| example | (Roche) | (Biomeme) | |
| Assay | PCR | PCR | LAMP |
| Isothermal | No | No | Yes |
| On spot assay | No | Yes | Yes |
| Pump or pipet | Yes | Yes | No |
| Enrichment | No | No | Yes |

The significance of this example lies in the following aspects. First, it will lead to an innovative system that can detect K. brevis on the spot, which will help address the challenges associated with red tides, including bloom formation/dissipation mechanisms and their impacts on human and animal populations. Second, VLEAD has a potential to be integrated with a drone that is capable of obtaining water samples by lowering a sampling bag into ocean, realizing remote water sampling and on-the-spot detection of red tide microalgae off-coast. Third, VLEAD can be further developed to be user-friendly and it can be operated by non-technical personnel. As a result, this VLEAD device will enable us to engage citizens for conducting coastal water surveillance, and will help manage and mitigate the effects of red tides on coastal residents, Florida visitors and animal populations.

One goal is to develop VLEAD for K. brevis detection. To enable VLEAD to detect K. brevis, we will develop LAMP primers. Our literature search found no previous efforts on using LAMP for K. brevis, thought there are a couple of reports on using LAMP for detecting other red tide causative species, including Karenia mikimotoi and Prorocentrum minimum. To design LAMP primers, we will retrieve the DNA sequence of K. brevis from GenBank. After homology analysis using BLAST (National Centre for Biotechnology Information), primers specific to the selected sequence in the rbcL gene from K. brevis will be designed using PrimerExplorer V5 (http://primerexplorer.jp/e/) according to the criteria described by Notomi et al. ⁴The primer designs will be optimized and experimentally validated for specificity and sensitivity.

Using either algal cells or their genomic DNA, we will obtain a calibration curve of the LAMP assay and then determine the limit of detection. We will run a positive control and a negative control along each sample as we practiced previously. In addition, it is well documented that LAMP is more tolerant to sample-derived inhibitors than PCR, significantly reducing false negatives. False positives often result from reagent contamination during assay steps. Using pre-packaged reagents in VLEAD without pipetting will eliminate these possible contamination sources.

In addition, we will modify the current VLEAD device to meet the requirement for K. brevis detection. One modification is related to the sample volume. Currently VLEAD can process 140 μL of saliva or urine samples and we will modify it to process 1-10 ml of water. Since VLEAD is fabricated using 3D printing, it is relatively easy to enlarge its geometry to match the volume requirement. Another possible improvement is to replace the coffee mug in FIG. 2.3 by integrating the detection unit with a microheater. The microheater will be either screen-printed or microfabricated on a thin film as we previously demonstrated for PCR in a microchamber. The microheater can be powered by a rechargeable battery, a computer, or a smart phone.

According to Florida Fish and Wildlife Conservation Commission (FFWCC), the red tide status is reported in five levels. They are “not present/background”, “very low”, “low”, “medium”, and “high”, corresponding to the concentration of K. brevis at 0-1K, 1K-10K, 10K-100K, 100K-1M, and >1M cells L⁻¹, respectively. Our goal is able to report each red tide level, with a limit of detection at the background level (i.e. <1,000 cells ^{L-1}).

To verify the detection specificity, we will use the VLEAD device to test K. brevis samples, K. mikimotoi samples, and their mixtures at the different concentration ratios. The presence of K. mikimotoi should have negligible effects on the detection sensitivity of the K. brevis assay. As mentioned above, we will also run a positive control and a negative control along each sample to eliminate false positives and false negatives.

Another goal is to validate the VLEAD in real-world samples. We will test VLEAD in a lab and in the field. Its performance will be compared with two standard methods: (1) microscope and (2) molecular detection consisting of bench-top sample preparation and conventional PCR assay. Laboratory K. brevis and K. mikimotoi samples will be obtained. Each sample will be divided into three portions. The first portion will be examined under microscope to confirm. The second portion will be processed in VLEAD as discussed in FIG. 2.1. The third portion will be processed using the standard method, by which algal cells will be collected by centrifugation, followed by DNA extraction and PCR.

After fully characterization of VLEAD using laboratory samples, the device will be further validated using water samples from Gulf Coast, and again the VLEAD performance will be compared with the standard methods including (1) microscope such as HABScope and (2) molecular detection such as Biomeme thermocyclers.

### Example 2 References

1. Jiang, et al., Angew. Chem. Int. Ed., 2018, 57, 17211-17214.
2. Nguyen, et al. J. Aquat. Anim. Health, 2018, 30, 302-311.
3. Zhao, et al., Chem. Rev., 2015, 115, 12491-12545.
4. Nixon, et al., Biomol. Detect. Quantif. 2014, 2, 4-10.
5. Koh, et al., Anal. Chem. 2003, 75, 4591-4598.
6. Hardison, et al., PLoS ONE, 2019, 14, e0218489.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that measurements, amounts, and other numerical data can be expressed herein in a range format. It is also understood that there are a number of values disclosed herein, and that each value is also herein disclosed as “approximately” that particular value in addition to the value itself. For example, if the value “10” is disclosed, then “approximately 10” is also disclosed. Similarly, when values are expressed as approximations, by use of the antecedent “approximately,” it will be understood that the particular value forms a further aspect. For example, if the value “approximately 10” is disclosed, then “10” is also disclosed.

As used herein, the terms “about,” “approximately,” “at or about,” and “substantially equal” can mean that the amount or value in question can be the exact value or a value that provides equivalent results or effects as recited in the claims or taught herein. That is, it is understood that amounts, sizes, measurements, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In general, an amount, size, measurement, parameter or other quantity or characteristic is “about,” “approximate,” “at or about,” or “substantially equal” whether or not expressly stated to be such. It is understood that where “about,” “approximately,” “at or about,” or “substantially equal” is used before a quantitative value, the parameter also includes the specific quantitative value itself, unless specifically stated otherwise.

Where a range is expressed, a further aspect includes from the one particular value and/or to the other particular value. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x,’ ‘about y,’ and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

1. A device for preparing a sample for nucleic acid detection comprising:
a buffer unit comprising a plurality of buffer wells arranged in a circular type shape, wherein each buffer well comprises a ball valve in a bottom of the well;
a mixing unit comprising a mixing well and a pin, wherein the mixing unit is connected to a bottom of the buffer unit such that the mixing unit is rotatable to align with each buffer well in turn, wherein when the mixing unit is aligned with a buffer well the pin engages with the ball valve to release fluid from the buffer well into the mixing well; and
a detection unit removably coupled to a bottom of the mixing unit to receive fluids from the mixing well; and
a waste container coupled to the bottom of the mixing unit, wherein the waste container comprises a well that receives fluids from the detection unit.

2. The device of claim 1, wherein the detection unit comprises an absorbent layer.

3. The device of claim 1, wherein the absorbent layer is selected from chromatography paper, cellulose paper, a membrane, FTA card, and glass microfiber paper.

4. The device of claim 1, wherein the waste container comprises a vacuum connection.

5. The device of claim 1, wherein the waste container comprises a flask-shaped cap, wherein the cap couples to the mixing unit.

6. The device of claim 1, wherein the nucleic acid is DNA or RNA

7. The device of claim 1, wherein the buffer unit comprising a plurality of buffer wells includes a first buffer well, a second buffer well, a third buffer well, and a fourth buffer well.

8. The device of claim 7, wherein the first buffer well contains a lysis solution, wherein the second buffer well contains a binding buffer, wherein the third buffer well contains a first wash buffer, and the fourth buffer well contains a second wash buffer.

9. The device of claim 1, further comprising a heating unit, wherein the heating unit comprises a seat for the detection unit, wherein the heating unit provides a temperature of 57° C. to 67° C.

10. The device of claim 1, wherein the circular type shape is a circle or a semi-circle.

11. A method of detection of a nucleic acid in a sample, comprising:
providing a fluid sample to a first buffer well of a device, the device comprising:
a buffer unit comprising a plurality of buffer wells arranged in a circular type shape, wherein each buffer well comprises a ball valve in a bottom of the well, wherein a first buffer well contains a lysis solution, wherein a second buffer well contains a binding buffer, wherein a third buffer contains a first wash buffer, and a fourth buffer well contains a second wash buffer;
a mixing unit comprising a mixing well and a pin, wherein the mixing unit is connected to a bottom of the buffer unit such that the mixing unit is rotatable to align with each buffer well in turn, wherein when the mixing unit is aligned with a buffer well the pin engages with the ball valve to release fluid from the buffer well into the mixing well; and
a detection unit removably coupled to a bottom of the mixing unit to receive fluids from the mixing well;
rotating the mixing unit or the buffer unit to engage the pin with the first buffer well such that the sample and the lysis solution releases into the mixing unit;
rotating the mixing unit or the buffer unit to engage the pin with the second buffer well such that the binding buffer releases into the mixing unit;
rotating the mixing unit or the buffer unit to engage the pin with the third buffer well such that the first wash buffer releases into the mixing unit;
rotating the mixing unit or the buffer unit to engage the pin with the fourth buffer well such that the second wash buffer releases into the mixing unit; and
removing the detection unit once all fluids have drained from the mixing unit through the detection unit, and wherein the detection unit contains nucleic acid obtained from the fluid sample.

12. The method of claim 11, further comprising adding an amplification mixture to the detection unit.

13. The method of claim 12, wherein the amplification mixture is a LAMP mixture or RT-LAMP mixture.

14. The method of claim 11, further comprising pipetting the amplification mixture to the detection unit.

15. The method of claim 11, further comprising adding the amplification mixture via a fifth buffer well before the detection unit is removed.

16. The method of claim 11, further comprising heating the detection unit in a heating unit to amplify the nucleic acid.

17-20. (canceled)

21. The method of claim 11, further comprising reconstituting the dried or lyophilized amplification mixture into the detection unit.

22. A system for preparing a sample for nucleic acid detection and for nucleic acid detection comprising: a device of claim 1 and a heating unit, wherein the detection unit is adjacent the heating unit.

23. The system of claim 22, wherein the heating unit further comprises at least one cartridge heater.

24. The system of claim 22, wherein the heating unit is a component of a portable analysis device, the analysis device further comprising a battery, a microscope, and a temperature control circuit, wherein the heating unit has a cap that provides a seat for the detection unit.
